(19) United States
(12) Patent Application Publication
(10) Pub. No.: US 2017/0026800 A1
(43) Pub. Date: Jan. 26, 2017

(54) METHOD FOR MEASURING SIGNAL AND ELECTRONIC DEVICE THEREOF

(71) Applicant: Samsung Electronics Co., Ltd., Gyeonggi-do (KR)

(72) Inventors: Changsoo KIM, Seoul (KR); Jong-Jin Kim, Gyeonggi-do (KR)

(73) Assignee: Samsung Electronics Co., Ltd.

(21) Appl. No.: 15/133,855

(22) Filed: Apr. 20, 2016

(30) Foreign Application Priority Data
Jul. 20, 2015 (KR) 10-2015-0102534

(51) Int. Cl. H04W 4/02; G01S 3/14; G01S 3/04; G01S 3/78; H04W 4/00; G06T 11/20

(52) U.S. Cl. CPC H04W 4/026; H04W 4/027; H04W 4/008; G06T 11/206; G01S 3/046; G01S 3/78; G01S 3/14

(57) ABSTRACT

The present disclosure provides a method for operating a first electronic device. The method includes detecting a movement of the first electronic device, receiving direction information of a second electronic device, and determining an azimuth angle of a heading direction of the first electronic device based on the received direction information of the second electronic device.

### PRIORITY

This application claims priority under 35 U.S.C. §119(a) to a Korean Patent Application filed in the Korean Intellectual Property Office on Jul. 20, 2015, and assigned Serial No. 10-2015-0102534, the entire content of which is incorporated herein by reference.

### BACKGROUND

1. Field of the Disclosure

The present disclosure relates generally to a method and apparatus for detecting a state of an electronic device in the electronic device.

2. Description of the Related Art

An electronic device has various sensors, thereby being capable of detecting information about the electronic device, or information of surroundings in which the electronic device is located. By using a signal detected by the sensor, the electronic device can detect a state in which the electronic device is placed or a state of the surroundings in which the electronic device is located. For example, the sensor can be a geomagnetic sensor. The electronic device can measure an azimuth angle of the Earth by an output of the geomagnetic sensor. By using the azimuth angle, the electronic device can display a map direction in a map application or display points of interest suitable to a direction in which a user looks in an augmented reality application.

Further, an electronic device may perform various functions in association with other devices. For example, the electronic device may consist of a main device (e.g., a mobile phone) and a wearable device (e.g., a watch phone). The wearable device may perform a communication function with other devices by means of the main device (e.g., mobile phone) or independently. However, due to instrument limitations, the wearable device cannot mount a hardware construction mounted on the main device. For example, the hardware constituent element may be the geomagnetic senor.

The geomagnetic sensor cannot be mounted on the wearable device because of problems such as a peripheral environment (e.g., a metal housing) causing a change in geomagnetic measurement, size, or a product price.

A wearable device or a small electronic device may have a limitation in mounting a component due to hardware or instrumental limitations. For example, the small electronic device may have a difficulty in mounting a geomagnetic sensor.

### SUMMARY

The present disclosure has been made to address at least the problems and disadvantages described above, and to provide at least the advantages described below.

Accordingly, an aspect of the present disclosure is to provide a method for measuring a signal and an electronic device.

Accordingly, another aspect of the present disclosure is to provide a method for an electronic device to acquire an azimuth angle of the electronic device dependent on a heading direction of the device using sensors. The sensors may be a geomagnetic sensor, an acceleration sensor, a gyro sensor, etc.

Accordingly, another aspect of the present disclosure is to provide a method for a first electronic device lacking a geomagnetic sensor to operate as a compass by acquiring, from a second electronic device having a geomagnetic sensor, direction information, including an azimuth angle, of the heading direction of the second electronic device, and thus, determine an azimuth angle of the first electronic device based on the acquired direction information of the second electronic device.

Accordingly, another aspect of the present disclosure is to provide a method for a first electronic device lacking a geomagnetic sensor to operate as a compass by correcting direction information acquired by a second electronic device having a geomagnetic sensor by using direction information, such as heading direction, posture, and rotation information, acquired by other sensors of the first electronic device. By correcting the direction information acquired from the second electronic device with direction information of the first electronic device, a more accurate azimuth angle of the first electronic device may be determined.

Accordingly, an aspect of the present disclosure is to provide a method for a first electronic device, e.g. a wearable device, not equipped with a geomagnetic sensor to receive geomagnetic sensor information from a second electronic device, e.g., a mobile phone, equipped with the geomagnetic sensor, and process the received output of the geomagnetic sensor of the second electronic device based on a heading direction of the first electronic device and thereby generate azimuth angle information of the first electronic device. Because the wearable device does not need to mount the geomagnetic sensor, it may produce a cost savings, and also prevent the wearable device from being affected by a magnetic field generated within the device as a result of mounting a geomagnetic sensor thereon.

In accordance with an aspect of the present disclosure, a method for operating a first electronic device includes detecting a movement of the first electronic device, receiving direction information of a second electronic device, and determining an azimuth angle of a heading direction of the first electronic device based on the received direction information of the second electronic device.

In accordance with another aspect of the present disclosure, a first electronic device includes a sensor for detecting a movement of the first electronic device, a communication unit for receiving direction information of a second electronic device, and a processor for determining an azimuth angle of a heading direction of the first electronic device based on the received direction information of the second electronic device.

In accordance with another aspect of the present disclosure, an electronic device includes at least one sensor for detecting a movement of the electronic device, a display, and at least one processor. The at least one processor controls to receive direction information of another electronic device, and determine an azimuth angle of a heading direction of the electronic device based on the received direction information of the other electronic device, and display information corresponding to the determined azimuth angle of the heading direction the electronic device through the display.

### BRIEF DESCRIPTION OF THE DRAWINGS

The above and other aspects, features, and advantages of the present disclosure will become more apparent from the following detailed description taken in conjunction with the accompanying drawings in which:

FIG. 1 is a block diagram of a configuration of a network environment including an electronic device, according to an embodiment of the present disclosure;

FIG. 2 is a block diagram of a configuration of an electronic device, according to an embodiment of the present disclosure;

FIG. 3 is a block diagram of a configuration of a program module of an electronic device, according to an embodiment of the present disclosure;

FIG. 4A and FIG. 4B are block diagrams of configurations of electronic devices, according to an embodiment of the present disclosure;

FIG. 5 illustrates a first electronic device and a second electronic device which measure and display azimuth angles, according to an embodiment of the present disclosure;

FIG. 6A and FIG. 6B are graphs of data measured by various sensors for determining an azimuth angle of a heading direction in a second electronic device, according to an embodiment of the present disclosure;

FIG. 6C illustrates an azimuth angle of a heading direction in a second electronic device, according to an embodiment of the present disclosure;

FIG. 7 is a flowchart of a method of a second electronic device, according to an embodiment of the present disclosure;

FIG. 8 is a flowchart of a method of a first electronic device, according to an embodiment of the present disclosure; and

FIG. 9 is a flowchart illustrating a method of correcting and acquiring direction information of a first electronic device using a second electronic device, according to an embodiment of the present disclosure.

### DETAILED DESCRIPTION OF THE EMBODIMENTS OF THE PRESENT DISCLOSURE

Various embodiments of the present disclosure are mentioned below with reference to the accompanying drawings in which like reference numerals refer to like elements. However, the embodiments described herein are not intended to limit the present disclosure to a specific embodiments, and the present disclosure should be understood to include various modifications, equivalents and/or alternatives of the embodiments of the present disclosure described herein.

In the present disclosure, the expressions “have”, “may have”, “comprise”, and “may comprise”, etc. indicate the existence of a corresponding feature (e.g., a numeral value, a function, an operation, or a constituent element such as a component, etc.), and do not exclude the existence of an additional feature.

In the present disclosure, the expressions “A or B”, “at least one of A or/and B”, and “one or more of A or/and B”, etc. may include all available combinations of items enumerated together. For example, “A or B”, “at least one of A and B”, and “at least one of A or B” may denote all cases of (1) including A, (2) including B, or (3) including all of A and B.

The expressions “1st”, “2nd”, “first” or “second”, etc. used in the present disclosure may modify various elements irrespective of order and/or importance, and are merely used to distinguish one element from another element and are not intended to limit the corresponding elements. For example, a first user device and a second user device may represent different user devices, regardless of order or importance. For example, a first element may be referred to as a second element without departing from the scope of the present disclosure. Likewise, a second element may be referred to as a first element.

When it is mentioned that an element (e.g., a first element) is (operatively or communicatively) “coupled” or “connected” with/to another element (e.g., a second element), it should be understood that first element may be directly coupled to the second element, or may be coupled to the second element through a third element. On the other hand, when it is mentioned that an element (e.g., a first element) is “directly coupled” or “directly connected” with/to another element (e.g., a second element), it should be understood that a third element does not exist between the first element and the second element.

The expression “configured (or set) to” used in the present disclosure may be used interchangeably with, for example, “suitable for”, “having the capacity to”, “designed to”, “adapted to”, “made to”, or “capable of” in based on the circumstances. The term “configured (or set) to” may not necessarily mean only “specifically designed to” in hardware. Instead, in some circumstances, the expression “device configured to” may mean that the device is “capable of” together with other devices or components. For example, the phrase “processor configured (or set) to perform A, B, and C” may mean an exclusive processor (e.g. an, embedded processor) for performing a corresponding operation, or a generic-purpose processor (e.g., a Central Processing Unit (CPU) or an Application Processor (AP)) executing one or more software programs stored in a memory device, thereby being capable of performing corresponding operations.

The terms used in the present disclosure are used merely to describe certain embodiments, and are not intended to limit the scope of other embodiments. The expression of the singular form may include the expression of the plural form, unless otherwise dictating clearly in context. The terms used herein, including technological or scientific terms, have the same meaning as those commonly understood by a person of ordinary skill in the art to which the present disclosure pertains. Among the terms used in the present disclosure, the terms defined in a general dictionary may be interpreted as having meanings consistent with their meanings in the context of the related technology, and are not to be interpreted in an ideal or excessively formal manner, unless defined clearly in the present disclosure. In some cases, terms defined in the present disclosure should not be interpreted to exclude embodiments of the present disclosure.

An electronic device according to various embodiments of the present disclosure may include at least one of a smanphone, a tablet Personal Computer (PC), a mobile phone, a video phone, an electronic book (e-book) reader, a desktop PC, a laptop PC, a netbook computer, a workstation, a server, a Personal Digital Assistant (PDA), a Portable Multimedia Player (PMP), a Moving Picture Experts Group (MPEG-1 or MPEG-2) Audio Layer 3 (MP3) player, a mobile medical instrument, a camera, or a wearable device. According to various embodiments, the wearable device may include at least one of an accessary type (e.g., a watch, a ring, a wristlet, an anklet, a necklace, glasses, a contact lens, or a Head-Mounted-Device (HMD), etc.), a fabric or clothing integrated type (e.g., electronic clothes), a body mount type (e.g., a skin pad or tattoo), or a bio-physical implantation type (e.g., an implantable circuit).

In some embodiments of the present disclosure, the electronic device may be a home appliance. The home appliance may include at least one of a television (TV), a Digital Versatile Disk (DVD) player, an audio system, a refrigerator, an air conditioner, a cleaner, an oven, a microwave, a washing machine, an air cleaner, a set-top box, a home automation control panel, a security control panel, a TV box (for example, Samsung HomeSync™, Apple TV™, or Google TV™), a game console (e.g., Xbox™, PlayStation™), an electronic dictionary, an electronic locking system, a camcorder, or an electronic frame.

In other embodiments of the present disclosure, the electronic device may include at least one of various medical instruments (e.g., various portable medical measurement instruments (i.e., a blood sugar measuring instrument, a heat rate measuring instrument, a blood pressure measurement instrument, or a body temperature measurement instrument, etc.), Magnetic Resonance Angiography (MRA) machine, Magnetic Resonance Imaging (MRI) machine, Computerized Tomography (CT) machine, a photographing machine, or an ultrasonic machine, etc.), a navigation device, a Global Navigation Satellite System (GNSS), an Event Data Recorder (EDR), a Flight Data Recorder (FDR), a car infotainment device, an electronic equipment for a ship (e.g., a navigation device for ship, a gyrocompass, etc.), avionics, a security instrument, a head unit for a car, an industrial or home robot, an Automatic Teller's Machine (ATM), a Point Of Sales (POS) machine, or an Internet of Things (IoT) device (e.g., an electric light bulb, various sensors, an electricity or gas meter, a sprinkler device, a fire alarm, a thermostat, a streetlight, a toaster, an exercise device, a hot water tank, a heater, a boiler, etc.).

According to some embodiments of the present disclosure, the electronic device may include at least one of a part of furniture or building/structure, an electronic board, an electronic signature receiving device, a projector, or various metering instruments (e.g., tap water, electricity, gas, or a radio wave metering instrument, etc.).

In various embodiments of the present disclosure, the electronic device may be one of the aforementioned various devices or a combination of the devices. The electronic device may be a flexible electronic device. Also, the electronic device of the present disclosure is not limited to the aforementioned devices, and may include a new electronic device based on technological developments.

An electronic device according to an embodiment is described below with reference to the accompanying drawings. In the present disclosure, the term ‘user’ may denote a person who uses the electronic device or a device (e.g., an artificial-intelligence electronic device) which uses the electronic device.

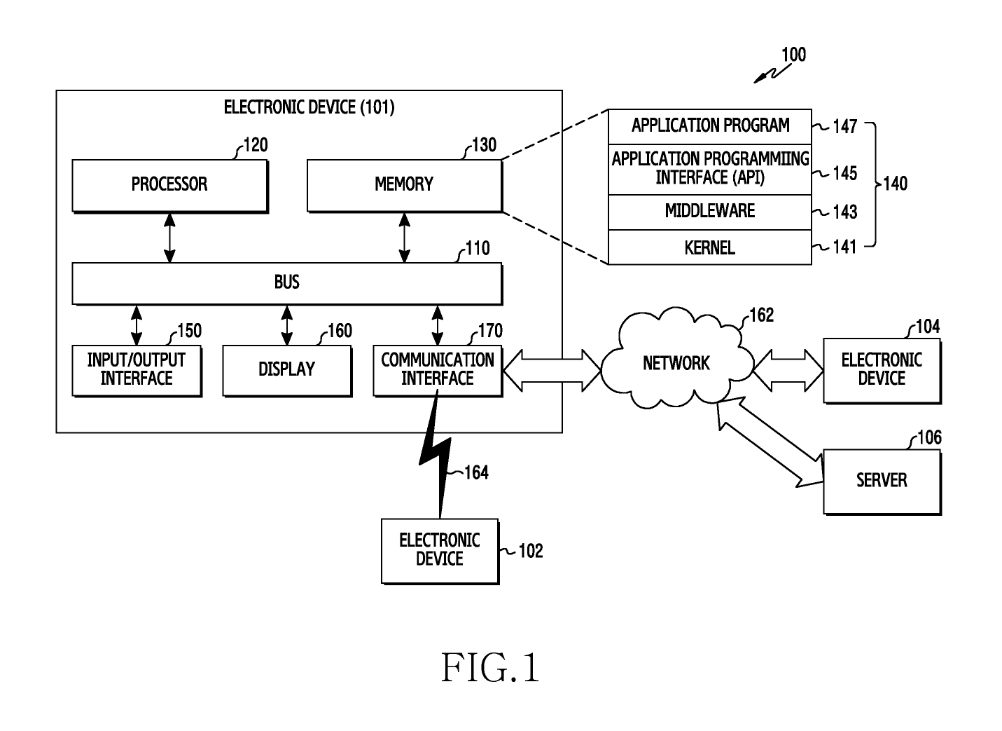

FIG. 1 is a block diagram of a network environment including an electronic device, according to an embodiment of the present disclosure.

Referring to FIG. 1, an electronic device 101 within a network environment 100 is provided. The electronic device 101 may include a bus 110, a processor 120, a memory 130, an input/output interface 150, a display 160, and a communication interface 170. The electronic device 101 may omit at least one of the elements or additionally have other elements.

The bus 110 may include a circuit connecting the elements 110 to 170 with one another and forwarding communication (e.g., a control message and/or data) between the elements.

The processor 120 may include one or more of a Central Processing Unit (CPU), an Application Processor (AP), or a Communication Processor (CP). The processor 120 may, for example, execute operation or data processing for control and/or communication of at least one other element of the electronic device 101.

The memory 130 may include a volatile and/or non-volatile memory. The memory 130 may, for example, store a command or data related to at least one other element of the electronic device 101. The memory 130 may store a software and/or program 140.

The program 140 may include a kernel 141, a middleware 143, an Application Programming Interface (API) 145, and/or an application program 147. At least some of the kernel 141, the middleware 143, or the API 145 may be called an Operating System (OS).

The kernel 141 may control or manage system resources (e.g., the bus 110, the processor 120, or the memory 130) used for executing operations or functions implemented in the other programs (e.g., the middleware 143, the API 145, or the application program 147). Also, the kernel 141 may provide an interface capable of controlling or managing the system resources by enabling the middleware 143, the API 145, or the application program 147 to gain access to the individual element of the electronic device 101.

The middleware 143 may perform an intermediary role of enabling the API 145 or the application program 147 to communicate and exchange data with the kernel 141.

Also, the middleware 143 processes one or more work requests received from the application program 147 in accordance with a priority order. For example, the middleware 143 may assign at least one of the application program 147 a priority order for using the system resources (e.g., the bus 110, the processor 120, or the memory 130, etc.) of the electronic device 101. For instance, the middleware 143 processes the one or more work requests in accordance with the priority order assigned to the at least one application program 147, thereby performing scheduling or load balancing for the one or more work requests.

The API 145 is an interface enabling the application 147 to control a function of the kernel 141 or the middleware 143, and may include at least one interface or function (e.g., an instruction) for file control, window control, image processing, or character control, etc.

The input/output interface 150 may play a role of an interface capable of forwarding, to the other elements of the electronic device 101, a command or data inputted from a user or another external device, e.g., a first external electronic device 102, a second external electronic device 104, or a server 106. Also, the input/output interface 150 may output, to the user or another external device, a command or data received from the other elements of the electronic device 101.

The display 160 may include a Liquid Crystal Display (LCD), a Light Emitting Diode (LED) display, an Organic Light Emitting Diode (OLED) display, or a microelectromechanical systems (MEMS) display, or an electronic paper display. The display 160 may display various contents (e.g., a text, an image, a video, an icon, or a symbol, etc.) to a user. The display 160 may include a touch screen and may receive a touch, gesture, proximity, or hovering input using an electronic pen or a part of a user's body.

The communication interface 170 may establish communication between the electronic device 101 and an external device (e.g., the first external electronic device 102, the second external electronic device 104, or the server 106. The communication interface 170 may be coupled to a network 162 through wireless communication or wired communication, and communicate with the external device (e.g., the second external electronic device 104 or the server 106 through the network 162.

The wireless communication may be a cellular communication protocol and may use at least one of Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM). Also, the wireless communication may include short-range communication 164.

The short-range communication 164 may include at least one of WiFi, Bluetooth (BT), Near Field Communication (NFC), or GNSS, etc. In accordance with a use area or a bandwidth, etc., the GNSS may include at least one of Global Positioning System (GPS), Global navigation satellite system (Glonass), Beidou navigation satellite system (Beidou) or Galileo, the European global satellite-based navigation system. Below, in the present disclosure, the “GPS” may be used interchangeably with the “GNSS”.

The wired communication may include at least one of Universal Serial Bus (USB), High Definition Multimedia Interface (HDMI), Recommended Standard-232 (RS-232), or Plain Old Telephone Service (POTS), etc.

The network 162 may include a telecommunications network, for example, a computer network (e.g., LAN or WAN), the Internet, or a telephone network.

The first and second electronic devices 102 and 104 each may be a device of the same or different kind from the electronic device 101.

According to an embodiment of the present disclosure, the server 106 may include a group of one or more servers.

According to an embodiment of the present disclosure, all or some of operations executed in the electronic device 101 may be executed in another or a plurality of electronic devices 102, 104 or the server 106. For example, in the case where the electronic device 101 is to perform a function or service automatically or in response to a request, the electronic device 101 may, instead of or additionally to executing the function or service in itself, transmit a request for at least a partial function associated with this to the external electronic device 102, 104 or the server 106. In this case, the external electronic device 102, 104 or the server 106 may execute the requested function or additional function, and forward the result to the electronic device 101. The electronic device 101 may process the received result as it is or additionally, and provide the requested function or service. For this, for example, a cloud computing, distributed computing, or client-server computing technology may be used.

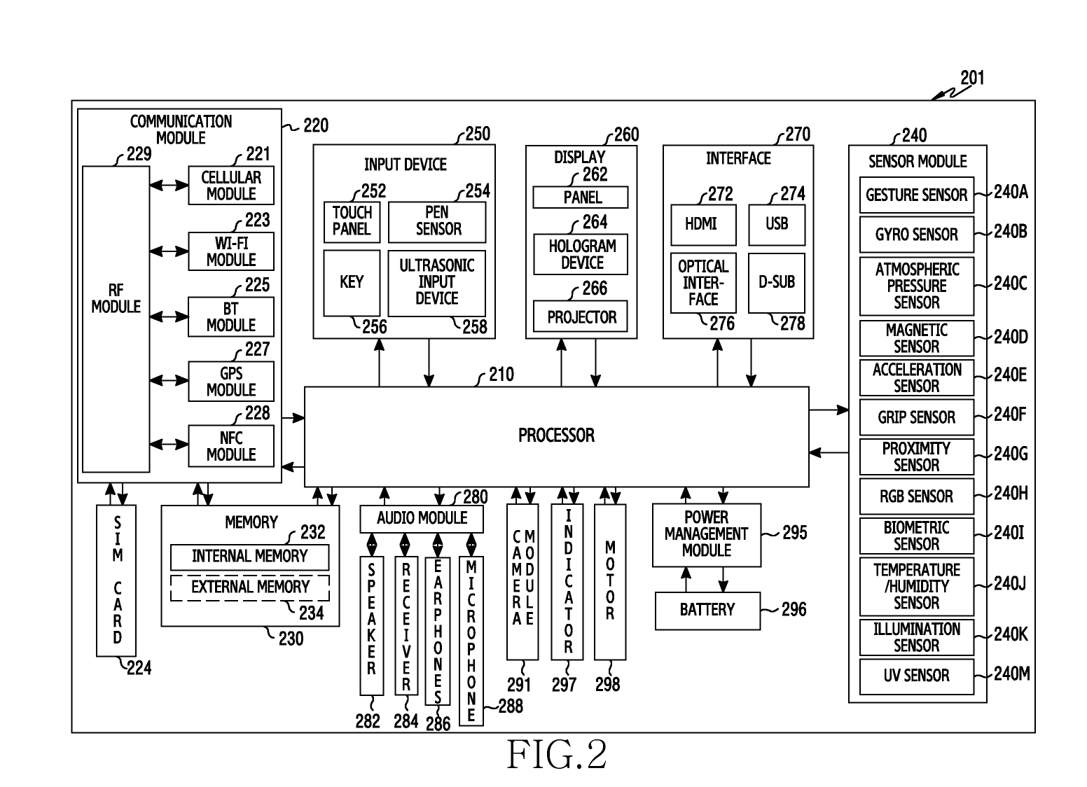

FIG. 2 is a block diagram of a configuration of an electronic device, according to an embodiment of the present disclosure.

Referring to FIG. 2, an electronic device 201 is provided. The electronic device 201 may include the entire configuration of the electronic device 101 illustrated in FIG. 1 or a part thereof.

The electronic device 201 may include one or more processors 210 (e.g., an application processor (AP)), a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may drive an operating system or an application program, controls a plurality of hardware or software elements coupled to the processor 210, and may perform various data processing and operations. The processor 210 may be, implemented as a System on Chip (SoC).

According to an embodiment of the present disclosure, the processor 210 may further include a Graphical Processing Unit (GPU) and/or an image signal processor. The processor 210 may include at least some (e.g., the cellular module 221) of the other elements shown in FIG. 2 as well.

The processor 210 may load a command or data received from at least one of the other elements (e.g., non-volatile memory), to a volatile memory, and processes the loaded command or data, and may store various data in the non-volatile memory.

The communication module 220 may have the same or similar construction as the communication interface 170 of FIG. 1. The communication module 220 may include a cellular module 221, a WiFi module 223, a BT module 225, a GNSS module 227 (e.g., a GPS module, a Glonass module, Beidou module, or a Galileo module), an NFC module 228, and a Radio Frequency (RF) module 229.

The cellular module 221 may provide voice telephony, video telephony, a text service, or an Internet service, etc., through a telecommunication network.

According to an embodiment of the present disclosure, the cellular module 221 may perform the distinction and authentication of the electronic device 201 within the telecommunication network, using the SIM card 224. The cellular module 221 may perform at least some functions among functions that the processor 210 may provide. The cellular module 221 may include a Communication Processor (CP).

According to an embodiment of the present disclosure, the WiFi module 223, the Bluetooth module 225, the GNSS module 227, or the NFC module 228 each may include a processor for processing data transmitted/received through the corresponding module. At least some of the cellular module 221, the WiFi module 223, the BT module 225, the GNSS module 227 or the NFC module 228 may be included within one Integrated Circuit (IC) or IC package.

The RF module 229 may transmit/receive a communication signal (e.g., RF signal). The RF module 229 may include a transceiver, a Power Amplifier Module (PAM), a frequency filter, a Low Noise Amplifier (LNA), or an antenna, etc.

According to another embodiment, at least one of the cellular module 221, the WiFi module 223, the Bluetooth module 225, the GNSS module 227 or the NFC module 228 may transmit/receive the RF signal through a separate RF module.

The SIM card 224 may include a card and/or an embedded SIM, including unique identification information (e.g., an Integrated Circuit Card Identifier (ICCID)) or subscriber information (e.g., an International Mobile Subscriber Identity (IMSI)).

The memory 230 (e.g., the memory 130) may include an internal memory 232 or an external memory 234.

The internal memory 232 may include at least one of a volatile memory (e.g., a Dynamic Random Access Memory (DRAM), a Static RAM (SRAM) or a Synchronous Dynamic RAM (SDRAM), etc.), a non-volatile memory (e.g., a One-Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., Not AND (NAND) flash, or Not OR (NOR) flash, etc.), a hard drive, or a Solid State Drive (SSD).

The external memory 234 may include a flash drive, for example, Compact Flash (CF), Secure Digital (SD), micro-SD, mini-SD, extreme Digital (xD), a Multi Media card (MMC), or a memory stick, etc. The external memory 234 may be operatively and/or physically coupled with the electronic device 201 through various interfaces.

The sensor module 240 may measure a physical quantity or detect an activation state of the electronic device 201, and convert the measured or detected information into an electric signal. The sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a Red, Green, Blue (RGB) sensor 240H, a medical sensor 240I, a temperature/humidity sensor 240J, an illumination sensor 240K, or a Ultraviolet (UV) sensor 240M. Additionally or alternatively, the sensor module 240 may include an E-nose sensor, an Electromyography (EMG) sensor, an Electroencephalogram (EEG) sensor, an Electrocardiogram (ECG) sensor, an InfraRed (IR) sensor, an iris scan sensor, and/or a finger scan sensor. The sensor module 240 may further include a control circuit for controlling at least one or more of the sensors therein.

In any embodiment of the present disclosure, the electronic device 201 may further include a processor configured to control the sensor module 240 as a part of the processor 210 or independently and thus, while the processor 210 is in a sleep state, the electronic device 201 may control the sensor module 240.

The input device 250 may include a touch panel 252, a (digital) pen sensor 254, a key 256, or an ultrasonic input device 258.

The touch panel 252 may use at least one scheme among a capacitive overlay scheme, a pressure sensitive scheme, an infrared beam scheme, or an ultrasonic scheme. The touch panel 252 may further include a control circuit. The touch panel 252 may further include a tactile layer, and provide a tactile response to a user.

The (digital) pen sensor 254 may be a part of a touch panel, or include a separate sheet for recognition.

The key 256 may include a physical button, an optical key, or a keypad.

The ultrasonic input device 258 may detect an ultrasonic wave generated in an input tool, through a microphone 288, and may identify data corresponding to the detected ultrasonic wave.

The display 260 (e.g., the display 160) may include a panel 262, a hologram device 264, or a projector 266.

The panel 262 may include the same or similar construction as the display 160 of FIG. 1. The panel 262 may be implemented to be flexible, transparent, or wearable. The panel 262 may be constructed as one module together with the touch panel 252.

The hologram device 264 may display a three-dimensional image in the air using an interference of light.

The projector 266 may project light to a screen and displays an image. The screen may be located inside or outside the electronic device 201.

According to an embodiment of the present disclosure, the display 260 may further include a control circuit for controlling the panel 262, the hologram device 264, or the projector 266.

The interface 270 may include an HDMI 272, a USB 274, an optical interface 276, or a D-subminiature (D-sub) 278.

The interface 270 may be included in the communication interface 170 shown in FIG. 1. Additionally or alternatively, the interface 270 may include a Mobile High-definition Link (MHL) interface, an SD card/Multi Media Card (MMC) interface, or an Infrared Data Association (IrDA) standard interface.

The audio module 280 may convert a sound and an electric signal interactively. At least some elements of the audio module 280 maybe included in the input/output interface 150 illustrated in FIG. 1. The audio module 280 may process sound information inputted or outputted through a speaker 282, a receiver 284, an earphone 286, or the microphone 288.

The camera module 291 may capture a still picture and a moving picture.

According to an embodiment of the present disclosure, the camera module 291 may include one or more image sensors (e.g., a front sensor or a rear sensor), a lens, an Image Signal Processor (ISP), or a flash (e.g., a Light Emitting Diode (LED), a xenon lamp, etc.).

The power management module 295 may manage electric power of the electronic device 201.

According to an embodiment of the present disclosure, the power management module 295 may include a Power Management Integrated Circuit (PMIC), a charger IC, or a battery 296, or a battery gauge.

The PMIC may have a wired and/or wireless charging method. The wireless charging method may, include a magnetic resonance scheme, a magnetic induction scheme, or an electromagnetic wave scheme, etc., and may further include a supplementary circuit for wireless charging, for example, a coil loop, a resonance circuit, or a rectifier, etc. The battery gauge may measure a level, in-charge voltage, current, or temperature of the battery 296.

The battery 296 may include a rechargeable battery and/or a solar battery.

The indicator 297 may display a specific status of the electronic device 201 or a part (e.g., the processor 210) thereof, for example, a booting state, a message state, or a charging state, etc.

The motor 298 may convert an electric signal into a mechanical vibration, and may generate a vibration, or haptic effect, etc.

The electronic device 201 may include a processing device (e.g., a GPU) for mobile TV support. The processing device for mobile TV support may process media data according to the standards of Digital Multimedia Broadcasting (DMB), Digital Video Broadcasting (DVB), or a media flow, etc.

According to an embodiment of the present disclosure, each of the elements described in the present disclosure may consist of one or more components, and a name of the corresponding element may vary according to the kind of an electronic device. The electronic device of the present disclosure may include at least one of the elements described herein, may omit some of the elements, or may further include additional elements. Also, some of the elements of the electronic device a may be combined and constructed as one entity, thereby identically performing the functions of the corresponding elements before combination.

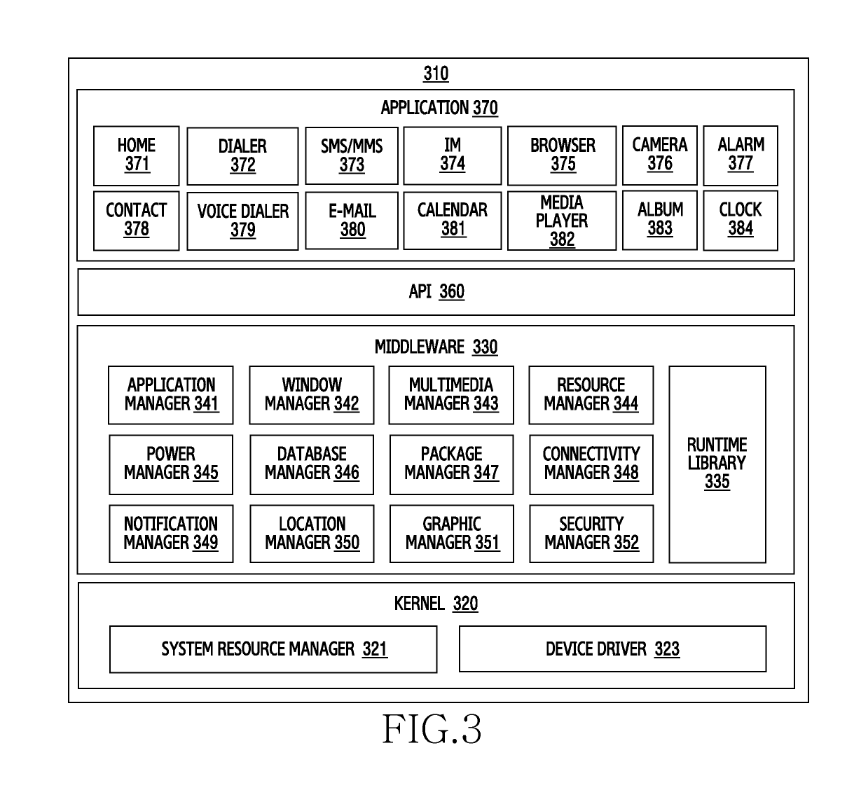

FIG. 3 is a block diagram of a program module of an electronic device, according to an embodiment of the present disclosure.

Referring to FIG. 3, a program module 310 (e.g., the program 140) is provided. The program module 310 may include an Operating System (OS) controlling resources related to the electronic device 101 and/or an application 370 (e.g., the application program 147) run on the operating system. The operating system may be Android, iPhone OS (iOS), Windows, Symbian, Tizen, Bada, etc.

The program module 310 may include a kernel 320, a middleware 330, an Application Programming Interface (API) 360, and/or an application 370. At least some of the program module 310 may be preloaded onto the electronic device 101, or may be downloaded from the external electronic device 102, 104, or the server 106.

The kernel 320 (e.g., the kernel 141) may include a system resource manager 321 and/or a device driver 323.

The system resource manager 321 may perform control of a system resource, allocation thereof, or recovery thereof, etc. The system resource manager 321 may include a process management unit, a memory management unit, or a file system management unit, etc.

The device driver 323 may include a display driver, a camera driver, a Bluetooth driver, a shared memory driver, a USB driver, a keypad driver, a WiFi driver, an audio driver, or an Inter-Process Communication (IPC) driver.

The middleware 330 may provide a common function of the application 370 or may provide various functions to the application 370 through the API 360 so that the application 370 may make efficient use of restricted system resources within the electronic device 101. The middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module that a compiler uses in order to add a new function through a programming language while the application 370 is executed. The runtime library 335 may perform input/output management, memory management, or a function of an arithmetic function, etc.

The application manager 341 may manage a life cycle of at least one application among the application 370.

The window manager 342 manages a GUI resource used by a screen.

The multimedia manager 343 may detect a format necessary for playing of various media files, and may perform encoding or decoding of the media file using a codec suitable to the corresponding format.

The resource manager 344 may manage a resource, such as a source code, a memory, or a storage space, of the application 370.

The power manager 345 may operate together with a Basic Input/Output System (BIOS), manage a battery or power supply, and provide power information necessary for an operation of the electronic device 101.

The database manager 346 may create, search, or change a database that will be used in the application 370.

The package manager 347 may manage installation or updating of an application distributed in a form of a package file.

The connectivity manager 348 may manage wireless connectivity, such as WiFi, BT, etc.

The notification manager 349 may display or notify a user of an event, such as an arrival of a message, an appointment, a proximity notification, etc. in a way that does not disturb the user.

The location manager 350 may manage location information of the electronic device 101.

The graphic manager 351 may manage a graphic effect to be provided to a user or a user interface.

The security manager 352 may provide a general security function necessary for system security, user authentication, etc.

In the case where the electronic device 101 includes a phone function, the middleware 330 may further include a telephony manager for managing a voice or video telephony function of an electronic device.

The middleware 330 may be a combination of the various functions of the aforementioned elements. The middleware 330 may be specific to the kind of operating system so as to provide a differentiated function. Also, the middleware 330 may dynamically delete some of the existing elements or add new elements.

The API 360 (e.g., the API 145) is a set of API programming functions, and may be provided to have a different construction in accordance with an operating system. For example, in case of Android or iOS, one API set by platform may be provided, and, in case of Tizen, two or more API sets by platform may be provided.

The application 370 (e.g., the application program 147) may include at least one or more applications capable of performing a function of a home 371, a dialer 372, a Short Message Service (SMS)/Multimedia Message Service (MMS) 373, an Instant Message (IM) 374, a browser 375, a camera 376, an alarm 377, a contact 378, a voice dialer 379, an electronic mail (e-mail) 380, a calendar 381, a media player 382, an album 383, and a watch 384. Alternatively or additionally, a health care (e.g., measuring a momentum or blood sugar, etc.) application or an environmental information application (e.g., providing air pressure, humidity, temperature information, etc.) may be provided.

According to an embodiment of the present disclosure, the application 370 may further include an information exchange application supporting information exchange between the electronic device 101 and the external electronic device (102 or 104. The information exchange application may include a notification relay application for relaying specific information to the external electronic device, or a device management application for managing the external electronic device.

The notification relay application may relay notification information generated in another application 370 (e.g., the SMS/MMS application, the e-mail application, the health care application, the environment information application, etc.) of the electronic device 101, to the external electronic device 102 or 104. Also, the notification relay application receives notification information from the external electronic device and provides the received notification information to a user.

The device management application may manage (e.g., installs, deletes, or updates) at least one function (e.g., turn-on/turn-off of the external electronic device itself (or a partial component) or adjustment of a brightness (or resolution) of a display) of the external electronic device 102 or 104 communicating with the electronic device 101, an application operating in the external electronic device, or a service (e.g., a telephony service or a message service, etc.) provided in the external electronic device.

The application 370 may further include an application (e.g., a health care application of a mobile medical instrument) designated according to an attribute of the external electronic device 102 or 104. The application 370 may include an application received from the external electronic device 102, 104, or the server 106. The application 370 may include a preloaded application, or a third party application downloadable from the server 106.

Names of the elements of the program module 310 may vary according to the kind of an operating system.

According to an embodiment of the present disclosure, at least some of the program module 310 may be implemented by software, firmware, hardware, or a combination thereof. At least some of the program module 310 may be implemented or executed by the processor 210. At least some of the program module 310 may include a module, a program, a routine, sets of instructions, or a process, etc. for performing one or more functions.

The term “module” used in the present disclosure may mean a unit including one of hardware, software, or firmware or a combination of two or more of them. The term “module” may be used interchangeably with the terms “unit”, “logic”, “logical block”, “component”, or “circuit”, etc. The “module” may be the minimum unit of an integrally constructed component or a part thereof. The “module” may be the minimum unit performing one or more functions or a part thereof as well. The “module” may be implemented mechanically or electronically. For example, the “module” may include at least one of an Application-Specific Integrated Circuit (ASIC) chip, Field Programmable Gate Arrays (FPGAs), or a programmable-logic device performing some operations, which are well known in the art or will be developed in the future.

At least a part of the electronic device 101 (e.g., modules or functions thereof) or method (e.g., operations) thereof may be implemented as an instruction stored in a computer-readable storage media in the form of a program module. In the case where the instruction is executed by the processor 120, the processor 120 may perform a function corresponding to the instruction. The computer-readable storage media may be the memory 130.

The computer-readable storage media may include a hard disk, a floppy disk, a magnetic media (e.g., a magnetic tape), an optical media (e.g., a Compact Disc-Read Only Memory (CD-ROM), a DVD, a Magneto-Optical Media (e.g., a floptical disk), a hardware device (e.g., a Read Only Memory (ROM), a Random Access Memory (RAM), a flash memory, etc.). Also, the program instruction may include, not only a mechanical language code such as a code made by a compiler but also, a high-level language code executable by a computer using an interpreter. The aforementioned hardware device may be configured to operate as one or more software modules so as to perform operations of the present disclosure, and vice versa.

The module or program module may further include at least one or more of the aforementioned elements, omit some, or further include additional elements. Operations carried out by the module, the program module, or the other elements may be executed in a sequential, parallel, repeated, or heuristic method. Also, some operations may be executed in a different order, may be omitted, or other operations may be added.

The embodiments of the present disclosure described herein haves been provided for explanation and understanding of technology content disclosed, and are not intended to limit the scope of the present disclosure. Accordingly, it should be interpreted that the scope of the present disclosure includes all changes based on the technological spirit of the present disclosure or various other embodiments.

For example, in an embodiment of the present disclosure, an electronic device may include all devices, such as information communication equipment, multimedia equipment, a wearable device, and appliance equipment, which use one or more of various processors (e.g., the processor 120, 210), such as an Application Processor (AP), a Communication Processor (CP), a Graphic Processing Unit (GPU), and a Central Processing Unit (CPU).

The disclosure describes a hardware access method as an example. However, the present disclosure is not intended to exclude a software based access method.

An embodiment of the present disclosure provides an apparatus and method in which an electronic device not including a specific construction (for example, a geomagnetic sensor) can receive and process an output of the corresponding construction from another electronic device. For example, when a wearable device, including no geomagnetic sensor, processes a map application, a navigation application, or an augmented reality application that uses an azimuth angle, the wearable device can receive information related with a geomagnetic sensor of another electronic device coupled through wireless communication, and determine the azimuth angle.

The azimuth angle information received from the other electronic device can vary according to a posture or state of the electronic device. Due to this, if the data is transmitted to the electronic device intact, it may be unmeaningful. However, if heading directions of the electronic device and the other electronic device are the same or if there is a point of a reference, the electronic device may recognize an azimuth angle of the other electronic device, using the received information of the geomagnetic sensor based on the heading direction or the reference point.

In an embodiment of the present disclosure, a first electronic device may be an electronic device (e.g., a wearable device) including no geomagnetic sensor, and a second electronic device may be an electronic device (e.g., a mobile phone) including a geomagnetic sensor. The first electronic device and the second electronic device may be carried by one person (i.e., user). Because the first electronic device and the second electronic device may be carried by one person, when the person moves, the first electronic device and the second device may measure a heading direction of the electronic devices (i.e., a heading direction of the user) by means of acceleration sensors and/or gyro sensors (i.e., gyroscopes) included in the first electronic device and second electronic device. For instance, the two electronic devices may detect information of the same heading direction. In this case, the first electronic device, including no geomagnetic sensor, may receive information related with the geomagnetic sensor of the second electronic device, from the second electronic device, including the geomagnetic sensor. The information related with the geomagnetic sensor, that the first electronic device receives from the second electronic device, may be azimuth angle information (i.e., a relative angle) of the second electronic device.

According to one embodiment of the present disclosure, the second electronic device may generate azimuth angle information (i.e., a relative angle) of a heading direction of the second electronic device based on information detected by the geomagnetic sensor and an acceleration sensor of the second electronic device, and transmits the generated azimuth angle information (i.e., relative angle) to the first electronic device. The first electronic device may process the azimuth angle information (i.e., relative angle) received from the second electronic device, based on a heading direction of the first electronic device, and determine an azimuth angle of the heading direction of the first electronic device.

According to another embodiment of the present disclosure, the first electronic device may determine an azimuth angle of a heading direction of the first electronic device, using information of an acceleration sensor and/or gyroscope of the first electronic device and azimuth angle information of the second electronic device that moves in the same direction as the first electronic device, and corrects the determined azimuth angle in accordance with a rotation or posture (i.e., position) of the first electronic device. For instance, because the first electronic device can obtain rotation information through the gyroscope, although the first electronic device is rotated, the first electronic device may calculate azimuth information of the first electronic device, through the received azimuth angle information of the second electronic device and a vector rotation determination method.

The first electronic device may provide azimuth angle information to a map or augmented reality application using an azimuth angle of a current heading direction of the first electronic device.

Accordingly, the azimuth angle may be provided to an electronic device failing to mount a geomagnetic sensor due to product price saving or instrumental limitation, and increase usability. For example, in the case where a smart watch is coupled with a smartphone, even if the smart watch is not equipped with a geomagnetic sensor, the smart watch may display a user's direction through a pedestrian navigator of the smart watch. The smart watch may display a rotation direction in a state where a user stands, using the azimuth angle information. In case of heading information using a GPS, it may be used even in a still state or at a low moving speed. Because even a wearable device providing augmented reality may obtain azimuth angle information with no geomagnetic sensor, accurate direction information provision may be possible.

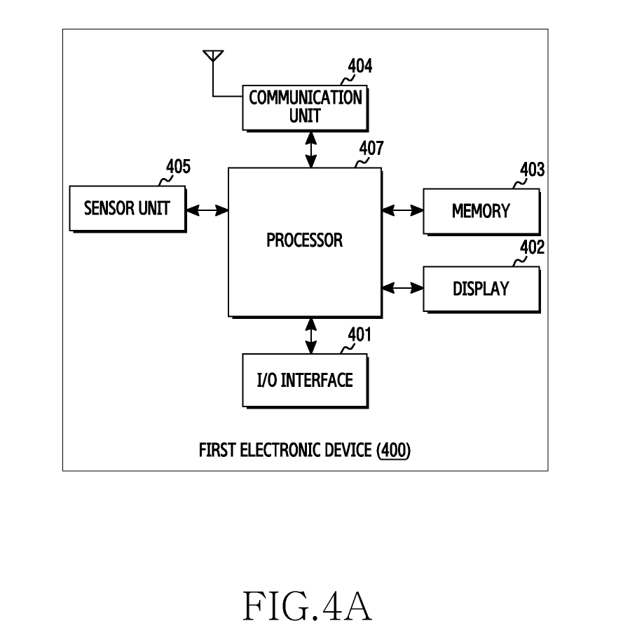

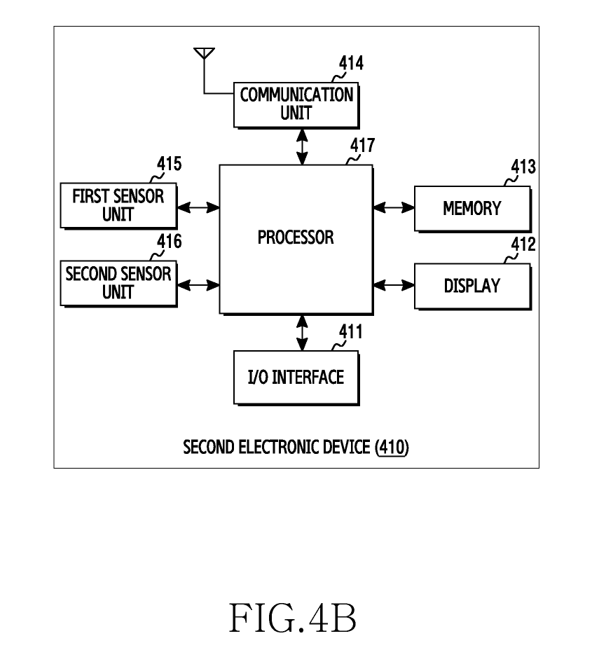

FIG. 4A and FIG. 4B are block diagrams of configurations of electronic devices, according to an embodiment of the present disclosure.

Referring to FIG. 4A a first electronic device 400, not including a geomagnetic sensor but, including a sensor unit 405 (e.g., an acceleration sensor, a gyroscope, etc.) for detecting a heading direction of the first electronic device 400 is provided. Referring to FIG. 4B a second electronic device 410 including a first sensor unit 415 (e.g., an acceleration sensor, a gyroscope, etc.) for detecting a heading direction of the electronic device 410 and a second sensor unit 416 (e.g., a geomagnetic sensor) for detecting a magnetic north direction is provided.

The second electronic device 410 acquires an azimuth angle of a heading direction of the second electronic device 410. The first electronic device 400 receives information of the azimuth angle of the heading direction acquired by the second electronic device 410 from the second electronic device 410, and displays the received azimuth angle information on a display 402 of the first electronic device 400. The first electronic device 400 and the second electronic device may be the electronic device 101 of FIG. 1.

An azimuth angle may be measured in a clockwise direction relative to the magnetic north. That is, in case of the clockwise direction, the azimuth angle may have a positive value (+) and, in case of a counterclockwise direction, the azimuth angle may have a negative value (−). However, it should be apparent to those skilled in the art that, in case of using a relative angle, the azimuth angle may be determined in another way by another reference.

Referring to FIG. 4A, the first electronic device 400 includes an Input/Output (I/O) interface 401, the display 402, a memory 403, a communication unit 404, the sensor unit 405, and a processor 407. According to an embodiment of the present disclosure, the first electronic device 400 may omit at least one of the elements or add other elements.

The input/output interface 401 may be an input unit of the first electronic device 400, and may generate a specific mode signal. The input/output interface 401 may be the input device 250 or the interface 270 of FIG. 2.

The sensor unit 405 may be a sensor detecting a heading direction of the first electronic device 400 and posture (i.e., position) information or rotation information of the first electronic device 400. That is, the sensor unit 405 may detect a heading direction, an acceleration, a rotation state, an inclined degree, etc. of the first electronic device 400. The sensor unit 405 may be a motion sensor (e.g., an acceleration sensor, a gyroscope). The sensor unit 405 may further include a proximity sensor or Heart Rate (HR) sensor for determining whether the first electronic device 400 (for example, a wearable device) is worn. The sensor unit 405 may be the gyro sensor 240B, the acceleration sensor 240E, the proximity sensor 240G, the medical sensor 240I, etc. disclosed in the sensor module 240 of FIG. 2. For example, the sensor unit 405 of the first electronic device 400 may take charge of the same function as the first sensor unit 415 of the second electronic device 410.

The display 402 may display azimuth angle information of a heading direction related to the fist electronic device 410 based on azimuth angle information of a heading direction received from the second electronic device 410 through the communication unit 404. For example, the display 402 may display second azimuth angle information of a heading direction which is generated based on first azimuth angle information of a heading direction received from the second electronic device 410. The second azimuth angle information is generated by processing the first azimuth angle information of a heading direction received from the second electronic device 410 based on posture or rotation information of the first electronic device 400. The display 402 may be the display 260 of FIG. 2.

The memory 403 may store heading direction information detected through the sensor unit 405 under the control of the processor 407 and, posture or rotation information of the first electronic device 400. The memory 403 may store azimuth angle information of a heading direction of the second electronic device 410 received from the second electronic device 410. The memory 403 may store the second azimuth angle information of a heading direction which is generated based on the first azimuth angle information of a heading direction received from the second electronic device 410. The memory 403 may be the memory 230 of FIG. 2.

The communication unit 404 may provide a communication function between the first electronic device 400 and the second electronic device 410. The communication unit 404 may receive azimuth angle information, heading direction information, posture information, etc. of the second electronic device 410, from the second electronic device 410, and may transmit heading direction information and posture information of the first electronic device 400 to the second electronic device 410. The communication unit 404 may be the communication module 220 of FIG. 2. For example, the communication unit 404 may be at least one of the WiFi module 223, the Bluetooth (BT) module 225, and the NFC module 228 of FIG. 2. The communication unit 404 may be a short-range wireless communication unit. The communication unit 404 may further be a BLE module or a Zigbee module.

The processor 407 may process heading direction information, posture information, and rotation information of the first electronic device 400, acquired through the sensor unit 405, and azimuth angle information of a heading direction of the second electronic device 410, received from the second electronic device 410. For example, the processor 407 may determine an azimuth angle of a heading direction of the first electronic device 400, using the azimuth angle information of the heading direction of the second electronic device 410 received from the second electronic device 410 and the heading direction information of the first electronic device 400. The processor 407 may further correct the determined azimuth angle of the heading direction of the first electronic device 400, based on posture and rotation information of the first electronic device 400.

The processor 407 may generate an azimuth angle of a heading direction of the first electronic device 410 by processing an azimuth angle of a heading direction of the second electronic device 410 in accordance with posture and/or rotation information (e.g., user's wrist up-operation) of the first electronic device 400, and display the azimuth angle of a heading direction of the first electronic device 410 on the display 402.

The second electronic device 410 may include an input/output interface 411, a display 412, a memory 413, a communication unit 414, a first sensor unit 415, a second sensor unit 416, and a processor 417. In an embodiment of the present disclosure, the second electronic device 410 may omit at least one of the elements or add other elements.

The input/output interface 411 may be an input unit of the second electronic device 410, may generate a specific mode signal. The input/output interface 411 may be the input device 250 or interface 270 of FIG. 2.

The first sensor unit 415 may be a sensor detecting a heading direction and posture or rotation information of the second electronic device 410. That is, the first sensor unit 415 may detect a heading direction of the second electronic device 410, an acceleration, a rotation state, an inclined degree, etc. The first sensor unit 415 may be a motion sensor (e.g., an acceleration sensor, a gyro sensor). The first sensor unit 415 may further include a proximity sensor or Heart Rate (HR) sensor for determining whether the second electronic device 410 is worn. The first sensor unit 415 may be the gyro sensor 240B, the acceleration sensor 240E, the proximity sensor 240G, the medical sensor 240I, etc. disclosed in the sensor module 240 of FIG. 2.

The second sensor unit 416 may be a sensor detecting magnetic north information. That is, the second sensor unit 416 may enable the second electronic device 410 to play the same role as a compass. For example, the second sensor unit 416 may be a geomagnetic sensor. The second sensor unit 416 may be the magnetic sensor 240D disclosed in the sensor module 240 of FIG. 2.

The display 412 may display magnetic north information (for example, the north (N) direction on a compass) measured through the second sensor unit 416. The display 412 may display not only a magnetic north but also a relative angle of a heading direction with respect to the north (i.e., an azimuth angle of the heading direction). The display 412 may be the display 260 of FIG. 2.

The memory 413 may store heading direction information detected through the first sensor unit 415 under the control of the processor 417, posture or rotation information of the second electronic device 410. The memory 413 may store magnetic north direction information measured through the second sensor unit 416 under the control of the processor 417. The memory 413 may store an azimuth angle of a heading direction that the processor 417 acquires using the heading direction, magnetic north, and posture/rotation information of the second electronic device 410. The memory 413 may be the memory 230 of FIG. 2.

The communication unit 414 may provide a communication function between the second electronic device 410 and the first electronic device 400. The communication unit 414 may transmit azimuth angle information of the second electronic device 410, that is, heading direction, posture, and rotation information of the second electronic device 410, to the first electronic device 400, and may receive heading direction or posture information of the first electronic device 400 from the first electronic device 400. The communication unit 414 may be the communication module 220 of FIG. 2. For example, the communication unit 414 may be at least one of the WiFi module 223, the BT module 225, and the NFC module 228 of FIG. 2. The communication unit 414 may further be a BLE module or a Zigbee module.

The processor 417 may process heading direction information acquired through the first sensor unit 415, posture and rotation information of the second electronic device 410, and magnetic north information acquired through the second sensor unit 416. For example, the processor 417 may determine a relative angle of a heading direction (i.e., an azimuth angle of the heading direction) with respect to a magnetic north direction using the user's heading direction information of the second electronic device 410 and the magnetic north information. The processor 417 may process the azimuth angle of the heading direction of the second electronic device 410 in accordance with posture and rotation information of the second electronic device 410, and displays the processed azimuth angle of the heading direction on the display 412.

The processor 417 may provide the determined azimuth angle information of the heading direction of the second electronic device 410 to the first electronic device 400, including no geomagnetic sensor, through the communication unit 414. As described above, an electronic device not having the geomagnetic sensor may receive azimuth angle information of a heading direction of another electronic device from another electronic device, and determine and display an azimuth angle of the electronic device using the received azimuth angle information. The electronic device may correct the determined azimuth angle based on posture or rotation information of the electronic device.

When executing a specific application (for example, a map application, a navigation application, etc.), the first electronic device 400 may transmit a request for information of the second sensor unit 416 to the second electronic device 410 through the communication unit 404.

The second electronic device 410 may detect an outputs of the first sensor unit 415 and the second senor unit 416, and generates new information based on the outputs of the first sensor unit 415 and second sensor unit 416. And, the second electronic device 410 may transmit the generated new information to the first electronic device 400. The generated new information may be transmitted to the first electronic device 400 in response to a request of the first electronic device 400, or may be automatically transmitted to the first electronic device 400 by the unit of a constant time.

The first electronic device 400 may receive the generated new information of the second electronic device 410 from the second electronic device 410, through the communication unit 404. When the first electronic device 400 receives the generated new information from the second electronic device 410, the first electronic device 400 may generate new information based on the sensor unit 405 of the first electronic device 400, and, the first electronic device 400 may display the generated new information on the display 402. The first electronic device 400 may be a wearable device, and the second electronic device 410 may be a mobile phone. Accordingly, the wearable device may be a device not mounting a geomagnetic sensor. And, when the wearable device transmits a request for first sensor unit 415 and second sensor unit 416 information of the mobile phone to the mobile phone, the mobile phone may detect a heading direction and a magnetic north direction and then, generate new information based on the detected information. For example, the mobile phone may generate azimuth angle information (i.e., azimuth angle information of the heading direction) dependent on the detected heading direction and magnetic north direction, and transmit the generated azimuth angle information to the wearable device through the communication unit 414. If so, the wearable device may combine the received azimuth angle information of the mobile phone with heading direction information (i.e., heading direction, posture (i.e., position), rotation information) of the wearable device detected in the sensor unit 405, and reset azimuth angle information of the wearable device

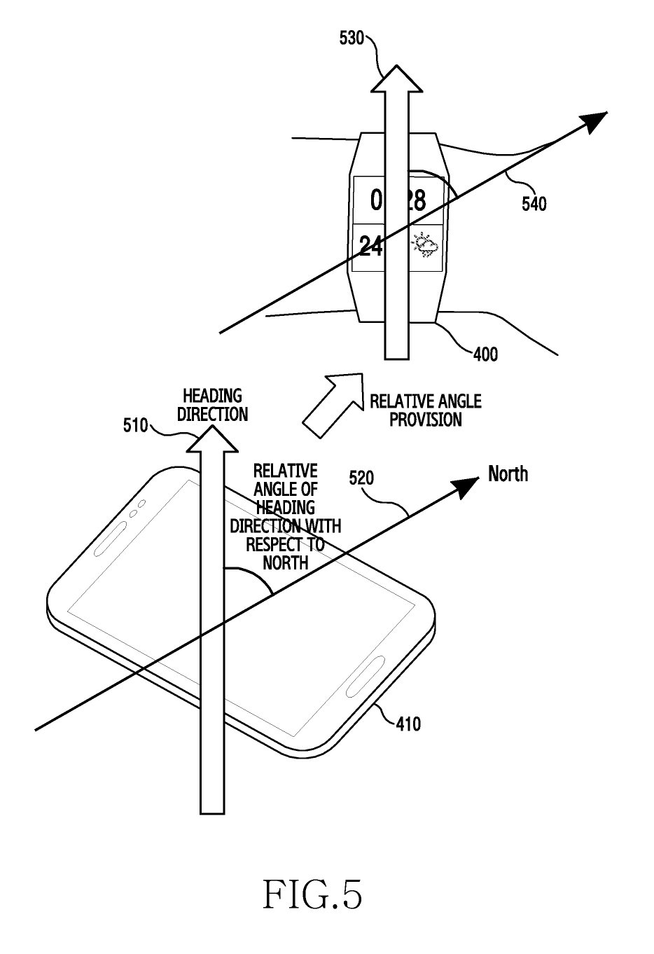

FIG. 5 illustrates a first electronic device and a second electronic device which measure and display azimuth angles, according to an embodiment of the present disclosure.

Referring to FIG. 5, it may be assumed a user of the first electronic device 400 and the second electronic device 410 are heading in any direction while carrying the first electronic device 400 and the second electronic device 410. Postures of the first electronic device 400 and the second electronic device 410 may vary depending on where the user is located. However, the heading direction of both devices may indicate the same direction because the first electronic device 400 and the second electronic device 410 and moving in the same direction. Arrows 510, 530 represent heading directions of the devices, and arrows 520, 540 represent the north, i.e., a magnetic north direction.

The second electronic device 410 may measure information such as a heading direction, a posture, an inclined degree, etc. of the second electronic device 410, through the first sensor unit 415. To acquire an azimuth angle of a heading direction of the second electronic device 410, the second electronic device 410 may measure magnetic north information through the second sensor unit 416. As a result, the processor 417 of the second electronic device 410 may acquire a relative angle (i.e., the azimuth angle of the heading direction) of the heading direction with respect to the north, using at least one of the measured heading direction and magnetic north information of the second electronic device 410.

The second electronic device 410 may transmit the acquired azimuth angle information of the heading direction of the second electronic device 410 to the first electronic device 400 through the communication unit 414. The second electronic device 410 may display the determined azimuth angle information of the heading direction of the second electronic device 410 on the display 412 of the second electronic device 410 as well.

The first electronic device 400 may receive the azimuth angle information of a heading direction that the processor 417 of the second electronic device 410 processes, from the second electronic device 410 through the communication unit 404.

To determine azimuth angle information of a heading direction dependent on posture and rotation information of the first electronic device 400 or a user's movement, the first electronic device 400 may measure heading direction, posture, and rotation information of the first electronic device 400, through the sensor unit 405.

The processor 407 of the first electronic device 400 may determine azimuth angle information of a heading direction of the first electronic device 400, using azimuth angle information of the heading direction information received from the second electronic device 410 and the heading direction information measured by the sensor unit 405 of the first electronic device 400. Thereafter, when a user's posture is changed (e.g., user's wrist-up operation), the processor 407 may correct the determined azimuth angle of the first electronic device 400 based on the measured posture information and/or rotation information of the first electronic device 400.

Even if the first electronic device 400 is changed in posture or is rotated, the first electronic device 400 may display, on the display 402, azimuth angle information of a heading direction dependent on a posture or rotation extent of the first electronic device 400. For example, no matter how a user arranges (i.e., rotates) the first electronic device 400, horizontally or vertically or suitably to the user's taste, the first electronic device 400 may display, on the display 402, a relative angle (i.e., the azimuth angle) of the heading direction with respect to the north, like a compass.

Thus, when the first electronic device 400 and the second electronic device 410 each recognize the same heading direction based on data measured through corresponding acceleration sensors and/or gyroscopes, the second electronic device 410 may determine an azimuth angle of a heading direction of the second electronic device 410 using acceleration sensor and/or gyroscope data and geomagnetic sensor data; and, the first electronic device 400 may determine an azimuth angle of a heading direction of the first electronic device 400 using the determined azimuth angle of the second electronic device 410 received from the second electronic device 410. The first electronic device 400 may then correct the determined azimuth angle of the first electronic device 400 in accordance with a heading direction change of the first electronic device 400 or a posture variation thereof. For example, based on the user's wrist-up movement, the first electronic device 400 may correct the determined azimuth angle information of the first electronic device 400 based on data measured by the acceleration sensor and/or gyro sensor of the first electronic device 400. That is, when the first electronic device 400 receives the azimuth angle of the second electronic device 410 from the second electronic device 410 and determines an azimuth angle of the first electronic device 400 with respect to a heading direction, the first electronic device 400 may reflect rotation information of the first electronic device 400 measured by the gyro sensor as well.

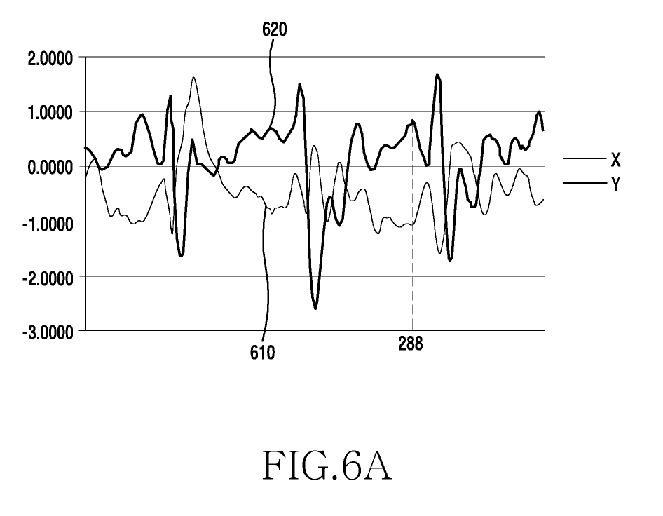

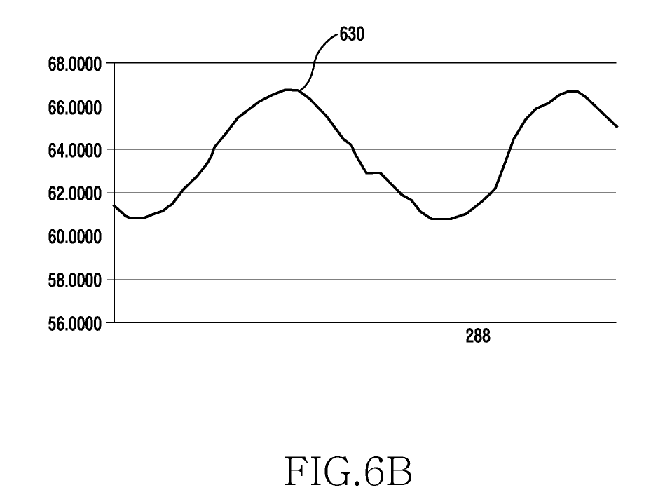

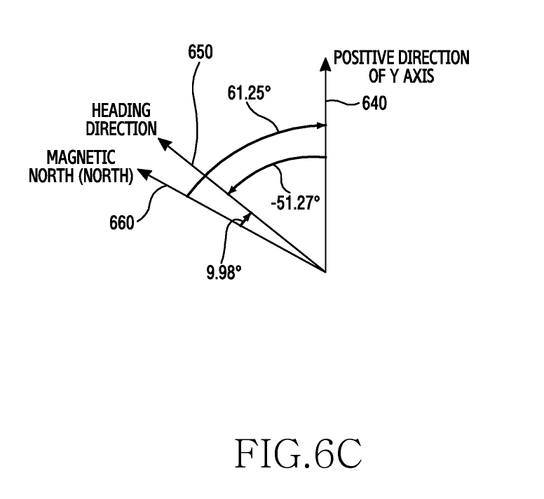

FIG. 6A to FIG. 6B are graphs of data measured by various sensors for determining an azimuth angle of a heading direction in a second electronic device, according to an embodiment of the present disclosure

Referring to FIG. 6A, a graph showing an acceleration 610 measured at an X axis of the first sensor unit 415 (e.g., the acceleration sensor) of the second electronic device 410, and an acceleration 620 measured at a Y axis of the first sensor unit 415 is provided (i.e., the X and Y axes of the first sensor unit 415 are in a mutual orthogonal state and are orthogonal to a Z axis passing the second electronic device 410). As shown in the graph, the second electronic device 410 may determine a relative angle of a heading direction with respect to a positive direction of the Y axis of the acceleration sensor (it is assumed that the second electronic device 410 is placed in a horizontal posture). For example, at a point 288 on the graph, where X=−1.06 g and Y=0.85 g the relative angle of the heading direction with respect to the positive direction of the Y axis of the acceleration sensor is measured as a tan (X/Y)=a tan (−1.06/0.85)=−51.27 degrees.

Referring to FIG. 6B, a graph showing magnetic north information measured in the second sensor unit 416 of the second electronic device 410 is provided. The graph represents a measured relative angle 630 of a positive direction of a Y axis with respect to a magnetic north direction. In the graph, a positive value (+) represents a clockwise direction. For example, at a point 288 on the graph, the measured relative angle 630 of the positive direction of the Y axis with respect to the magnetic north direction is 61.25 degrees.

FIG. 6C illustrates an azimuth angle of a heading direction in a second electronic device, according to an embodiment of the present disclosure.

Referring to FIG. 6C, an up direction of a Y axis 640 is a positive direction, and a down direction of the Y axis is a negative direction. Arrow 650 denotes a heading direction, and arrow 660 denotes the magnetic north direction.

Based on the point 288 shown in FIG. 6A, a relative angle of a heading direction 650 with respect to a positive direction 640 of a Y axis measured by the first sensor unit 415 (i.e., acceleration sensor) of the second electronic device 410 is −51.27 degrees. If the second electronic device 410 rotates 51.27 degrees in a counterclockwise direction from the positive direction 640 of the Y axis, the heading direction becomes the heading direction 650.

Further, based on the point 288 shown in FIG. 6B, the relative angle of the positive direction 640 of the Y axis with respect to the magnetic north direction 660 measured by the second sensor unit 416 of the second electronic device 410 is 61.25 degrees. In other words, the positive direction 640 of the Y axis exists at a direction in which the second electronic device 410 rotates 61.25 degrees in a clockwise direction from the magnetic north direction 660.

Therefore, the relative angle of the heading direction 650 with respect to the magnetic north direction 660 becomes 61.25−51.27=9.98 degrees. That is, the azimuth angle of the heading direction 650 is 9.98 degrees and, as shown in FIG. 6C, the heading direction 650 is dislocated by 9.98 degrees in the clockwise direction from the magnetic north direction 660.

Referring to FIG. 5 and FIG. 6C, the 9.98 degrees may be the azimuth angle of the heading direction with respect to the north processed by the second electronic device 410. Thus, in FIG. 5, the azimuth angle that the first electronic device 400 receives is 9.98 degrees. The first electronic device 400 may receive the azimuth angle 9.98 degrees from the second electronic device 410 and, using the azimuth angle of 9.98 degrees, generates a new azimuth angle of a heading direction dependent on posture or rotation information of the first electronic device 400. The first electronic device 400 may display the generated new azimuth angle information on the display 402 of the first electronic device 400.

According to an embodiment of the present disclosure, a first electronic device includes a sensor for detecting a movement of the first electronic device, a communication unit for receiving direction information of a second electronic device from the second electronic device, and a processor for determining an azimuth angle of the first electronic device based on the received direction information of the second electronic device. The device may further include a display displaying information corresponding to the determined azimuth angle.

The first electronic device receives, as the direction information of the second electronic device, an azimuth angle of a heading direction of the second electronic device, which is obtained based on the heading direction of the second electronic device and the magnetic north direction.

The sensor acquires movement information of the first electronic device, and the movement information may include at least one of heading direction information, posture information, and rotation information.

The processor determines the azimuth angle of the first electronic device based on the heading direction information of the first electronic device and the received direction information of the second electronic device. The processor further determines azimuth angle information of a heading direction of the first electronic device in consideration of at least one of the posture information of the first electronic device and the rotation information of the first electronic device. If movement of the first electronic device is detected in the course of determining the azimuth angle information, the processor may correct the azimuth angle of the first electronic device based on the detected movement of the first electronic device.

The first electronic device is a wearable device, and may further include a wearing detection sensor capable of, before detecting the movement of the wearable device, determining the user's wearing or non-wearing of the wearable device. The wearing detection sensor may include at least one of a proximity sensor, a heart-beat sensor, a touch sensor, and a medical sensor.

Before detecting the movement of the first electronic device, the processor may form a communication link with the second electronic device through the communication unit. The communication unit may include at least one of WiFi, Bluetooth, NFC, and ZigBee communication units.

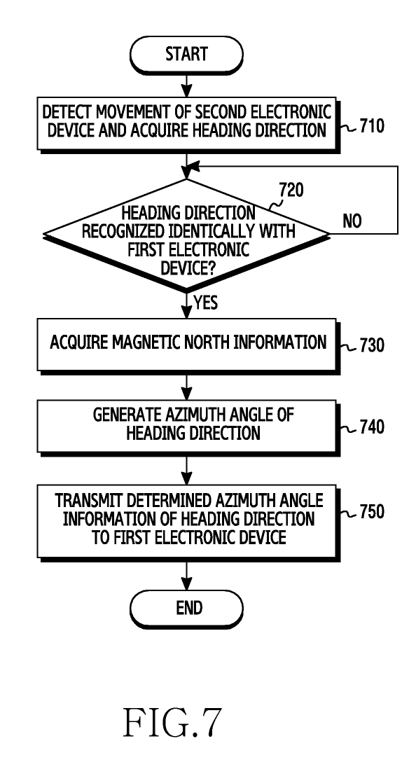

FIG. 7 is a flowchart of a method of a second electronic device, according to an embodiment of the present disclosure.

Referring to FIG. 7, a method of the second electronic device 410 including the first sensor unit 415 (e.g., an acceleration sensor, a gyro sensor, etc.) and the second sensor unit 416 (e.g., a geomagnetic sensor) is provided.

The second electronic device 410 may be activated at a time of receiving a request for transmission of specific information from the first electronic device 400, at a time of transmitting the specific information to the first electronic device 400, or at a time when movement of the second electronic device 410 is detected.

The specific information may be azimuth angle information of the second electronic device 410. The azimuth angle information may be relative azimuth angle information dependent on a heading direction of the second electronic device 410.

In operation 710, the second electronic device 410 may monitor for a movement of the second electronic device 410 using the first sensor unit 415 of the second electronic device 410. That is, the second electronic device 410 may detect when there is a movement of the second electronic device 410 using the first sensor unit 415 of the second electronic device 410. If the movement is detected, the second electronic device 410 may determine a heading direction of the second electronic device 410 using the first sensor unit 415 of the second electronic device 410. That is, the second electronic device 410 may acquire heading direction information at the same time the movement of the second electronic device 410 is detected.

In operation 720, the second electronic device 410 may check if it heading directions of the second electronic device 410 and the first electronic device 400 are identical. The second electronic device 410 may receive data measured by a sensor unit 405 (e.g. an acceleration sensor) of the first electronic device 400, from the first electronic device 400 through the communication unit 414. In this case, the second electronic device 410 may compare the data received from the first electronic device 400 with data measured by the first sensor unit 415 of the second electronic device 410, and check whether the heading directions of the two electronic devices are the same.

If it is determined that the second electronic device 410 and the first electronic device 400 have identical heading directions, then in operation 730, to determine an azimuth angle of the heading direction of the second electronic device 410, the second electronic device 410 acquires magnetic north information of the second electronic device 410, using the second sensor unit 416.

In operation 740, the second electronic device 410 may process the magnetic north information and heading direction information, and generate azimuth angle information of the heading direction of the second electronic device 410. For example, the second electronic device 410 may acquire the azimuth angle information of the heading direction of the second electronic device 410 in the manner described with respect to FIG. 6A to FIG. 6C.

In operation 750, the second electronic device 410 may transmit the generated azimuth angle information of the second electronic device 410 to the first electronic device 400 through the communication unit 414.

For example, the second electronic device 410 may transmit the azimuth angle information of the second electronic device 410 to the first electronic device 400 when acceleration sensors determine heading directions as the first electronic device 400 and the second electronic device 410 move. When the heading directions are determined to be identical based on measurement values of the acceleration sensors, the second electronic device 410 may generate azimuth angle information of the heading direction of the second electronic device 410 using the acceleration sensor data and data of a geomagnetic sensor and transmit the generated azimuth angle information of the second electronic device 410 to the first electronic device 400. The first electronic device 400 may then determine an azimuth angle of the heading direction of the first electronic device 400 using the received azimuth angle information of the second electronic device 410.

If the first electronic device 400 is a wearable device, the first electronic device 400 may include a sensor for detecting whether the first electronic device 400 is worn. The sensor may be, for example, a proximity sensor or HR sensor. If it is detected that the first electronic device 400 is worn, the first electronic device 400 may transmit wearing detection information to the second electronic device 410. If there is a detection of a movement, the first electronic device 400 and the second electronic device 410 may determine heading directions and check if the heading directions of the two electronic devices are identical. When the heading directions are the same the second electronic device 410 generates an azimuth angle (i.e., relative angle) of the heading direction of the second electronic device 410 and transmits the azimuth angle of the second electronic device 410 to the first electronic device 400.

Prior to operation 710, i.e., before detecting the movement of the second electronic device 410, the second electronic device 410 may be previously coupled with the first electronic device 400 using a short-range communication scheme. The short-range communication scheme may include at least one of WiFi, BT, BLE, NFC, and Zigbee schemes.

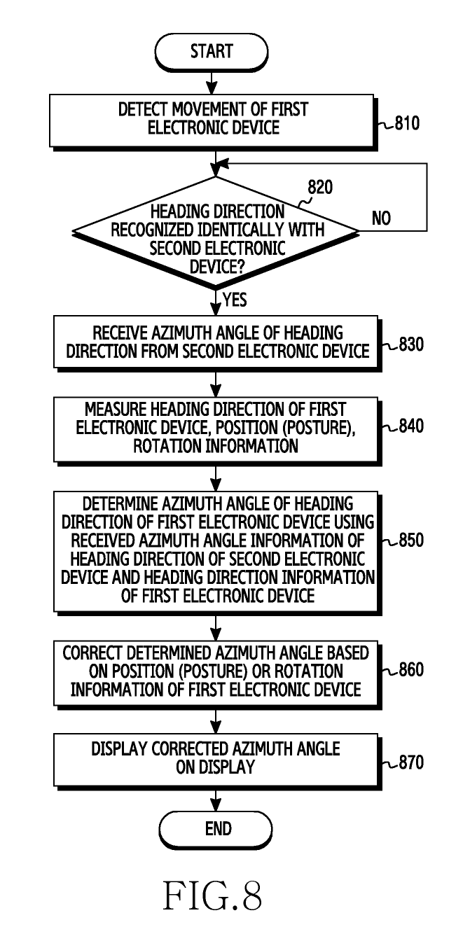

FIG. 8 is a flowchart of a method of a first electronic device, according to an embodiment of the present disclosure.

Referring to FIG. 8, a method of the first electronic device 400, including the sensor unit 405 (e.g., an acceleration sensor, a gyro sensor, etc.), but not including a geomagnetic sensor, is provided.

When executing an application (for example, a map application, a navigation application, an augmented reality application, etc.) displaying an azimuth angle, the first electronic device 400 may transmit, to the second electronic device 410, a request for azimuth angle information (i.e., relative angle) of a heading direction of the second electronic device 410. Alternatively, when the first electronic device 400 detects its own movement, the first electronic device 400 may transmit the second electronic device 410 a request for the azimuth angle information of a heading direction of the second electronic device 410. Alternatively still, by setting time periods, the first electronic device 400 may automatically receive azimuth angle information of the second electronic device 410 from the second electronic device 410 as well.

If there is a request for execution of an application needing azimuth angle display as described above, then in operation 810, the first electronic device 400 may monitor a movement of the first electronic device 400 using the sensor unit 405. That is, the first electronic device 400 may detect when there is a movement of the first electronic device 400 by means of the sensor unit 405. If the movement is detected, the first electronic device 400 may determine a heading direction of the first electronic device 400 using the sensor unit 405. That is, the first electronic device 400 may acquire heading direction information at the same time the movement of the first electronic device 400 is detected.

In operation 820, the first electronic device 400 may check whether the heading directions of the first electronic device 400 and the second electronic device 410 are identical. The first electronic device 400 may receive data measured by a first sensor unit 415 (e.g., an acceleration sensor, gyro sensor, etc.) of the second electronic device 410, from the second electronic device 410 through the communication unit 404. The first electronic device 400 may compare the data received from the second electronic device 410 with data measured by the sensor unit 405 of the first electronic device 400, and check whether the heading directions of the two electronic devices are the same.

In operation 830, the first electronic device 400 may receive the azimuth angle information of the heading direction of the second electronic device 410, from the second electronic device 410 through the communication unit 404. That is, in operation 830, the first electronic device 400 may receive the azimuth angle information (i.e., relative angle) of the heading direction of the second electronic device 410 that the second electronic device 410 transmits in operation 750 of FIG. 7. The first electronic device 400 does not immediately display the received azimuth angle information of the heading direction of operation 830, because the heading direction displayed on the display 402 of the first electronic device 400 may vary according to posture or rotation information of the first electronic device 400.

In operation 840, the first electronic device 400 may measure the heading direction information of the first electronic device 400, in consideration of posture and rotation information of the first electronic device 400, acquired using the sensor unit 405 of the first electronic device 400.

According to an embodiment of the present disclosure, the measuring of the heading direction information, posture information, rotation information, etc. of operation 840 may be achieved in operation 810 to operation 820 as well. In other words, operation 840 may be executed in operation 810 or operation 820 as well. For example, at the same time as detecting the movement of the first electronic device 400, the first electronic device 400 may measure the heading direction, posture, and rotation information of the first electronic device 400 as well.

In operation 850, the first electronic device 400 may determine azimuth angle information of a heading direction of the first electronic device 400, using the received azimuth angle information of the second electronic device 410 (i.e., the relative azimuth angle information dependent on the heading direction of the second electronic device 410) of operation 830 and the measured heading direction information of the first electronic device 400 of operation 840.

In operation 860, the first electronic device 400 may correct the determined azimuth angle information of the heading direction of the first electronic device 400 of operation 850 in accordance with the measured posture information or rotation information of the first electronic device 400. As described above, because a posture may vary for each electronic device, an electronic device may not use azimuth angle information of another electronic device as it is. The first electronic device 400 may determine the azimuth angle information of the first electronic device 400 based on posture or rotation information of the first electronic device 400, and using the received azimuth angle information of the second electronic device 410.

For example, at a user's wrist-up operation, the first electronic device 400 may correct the azimuth angle of the heading direction of the first electronic device 400, using the posture and rotation information of the first electronic device 400 measured by the sensor unit 405 of the first electronic device 400.

In operation 870, the first electronic device 400 may display the corrected azimuth angle of the heading direction of the first electronic device 400 on the display 402 of the first electronic device 400. An application displayed on the display 402 may be a map application, a navigation application, an augmented reality application, etc.

For example, if a user executes the map application and rotates the first electronic device 400 to determine the north and an azimuth angle of a heading direction relative to a current position, the first electronic device 400 displays the north and the heading direction on the display 402, like a compass.

Prior to operation 810, i.e., before detecting the movement of the first electronic device 400, the first electronic device 400 may be previously coupled with the second electronic device 410 using a short-range communication scheme. The short-range communication scheme may include at least one of WiFi, BT, BLE, NFC, and Zigbee schemes.

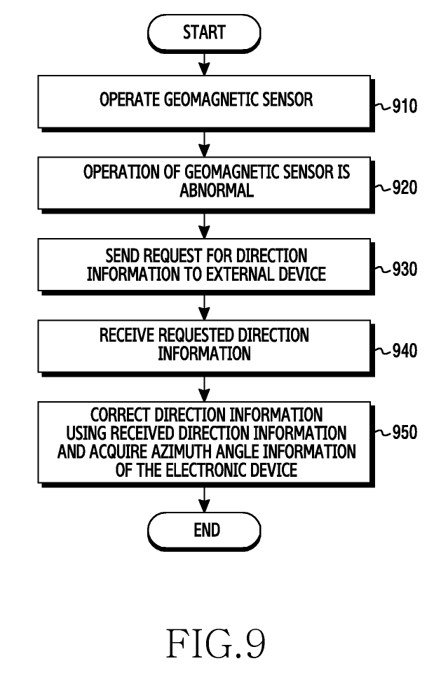

FIG. 9 is a flowchart illustrating a method of correcting and acquiring direction information of a first electronic device using a second electronic device, according to an embodiment of the present disclosure.

Referring to FIG. 9, when the first and the second electronic devices both have geomagnetic sensors, there may be a case where there is a failure to use the geomagnetic sensor of one electronic device. For example, this may occur in the case of a malfunction of the geomagnetic sensor, a reading failure of the geomagnetic sensor caused by the peripheral environment, or when the electronic device is being wireless charged. In such cases, the electronic device having the failure may receive direction information from the other electronic device having the functioning geomagnetic sensor, and thus may correct and acquire its direction information.

In operation 910, the electronic device activates and operates the geomagnetic sensor of the electronic device. For example, as described with respect in FIGS. 7 and 8, the geomagnetic sensor of the electronic device may be activated and operated when a movement of the electronic device is recognized or there is a request for direction information.

In operation 920, the electronic device may check if the geomagnetic sensor is abnormally operated. In case where the geomagnetic sensor is not operated or is not able to read a constant value, it may be determined that the geomagnetic sensor is abnormal.

In operation 930, the electronic device whose geomagnetic sensor is abnormally operated may transmit a request for direction information to an external electronic device having a functioning geomagnetic sensor. However, if a user determines that the external electronic device with the functional geomagnetic sensor is unstable, the electronic device may transmit a request for direction information to an external electronic device having a more stable geomagnetic sensor.

In operation 940, the electronic device may receive the requested direction information from the external electronic device. For example, the electronic device may receive magnetic north information, heading direction information, etc. that are measured by the geomagnetic and other sensors (e.g., an acceleration sensor, a gyroscope) of the external electronic device and. Operation 940 may be performed in the same method as operation 830 shown in FIG. 8. For instance, the electronic device may receive relative information as in operation 830.

In operation 950, the electronic device may correct direction information of the electronic device using the received direction information. Operation 950 may use the same method as operation 850 and operation 860 of FIG. 8. The electronic device acquires azimuth angle information dependent on a heading direction of the electronic device, using the received direction information.

According to various exemplary embodiments of the present disclosure, a first electronic device may detect a movement of the first electronic device, receive direction information of a second electronic device from the second electronic device, and determine an azimuth angle of a heading direction of the first electronic device based on the acquired direction information of the second electronic device. In addition, the first electronic device may display information corresponding to the determined azimuth angle of the first electronic device.

According to one exemplary embodiment, the direction information of the second electronic device received from the first electronic device may include an azimuth angle of a heading direction of the second electronic device, which is obtained based on the heading direction of the second electronic device and a magnetic north direction.

In a method for operating the first electronic device, the operation of detecting the movement of the first electronic device comprises acquiring movement information of the first electronic device, and the movement information may further include at least one of heading direction information of the first electronic device, posture information of the first electronic device, rotation information of the first electronic device.

In the method for operating the first electronic device, the operation of determining the azimuth angle of the heading direction the first electronic device may determines the azimuth angle of the heading direction the first electronic device based on the heading direction information of the first electronic device and the received direction information of the second electronic device. The operation of determining the azimuth angle of the heading direction of the first electronic device may determine azimuth angle information of a heading direction of the first electronic device by more reflecting at least one of the posture information of the first electronic device, the rotation information the first electronic device. If detecting the movement of the first electronic device in course of determining the azimuth angle information, the first electronic device may correct the azimuth angle of the first electronic device based on the detected movement.

According to various exemplary embodiments of the present disclosure, the first electronic device is a wearable device and, before detecting the movement of the wearable device, may determine whether the first electronic device is worn, using a wearing detection sensor of the wearable device. The wearing detection sensor may include at least one of a proximity sensor, a heart-beat sensor, a touch sensor, a medical sensor.

According to one exemplary embodiment, before detecting the movement of the first electronic device, the first electronic device may form a link with the second electronic device using a short-range wireless communication scheme. The short-range wireless communication scheme may include at least one of WiFi, Bluetooth, NFC, ZigBee communication schemes.

The method for operating the first electronic device may further include the operation of, if a specific application is executed, forming a short-range communication link with the second electronic device and recognizing the movement of the first electronic device. The specific application may include an application displaying a map.

A method for operating an electronic device according to various exemplary embodiments of the present disclosure may acquire an azimuth angle of the electronic device dependent on a heading direction using sensors. The sensors may be a geomagnetic sensor, an acceleration sensor, a gyro sensor, etc. For example, a first electronic device not equipped with a geomagnetic sensor may receive geomagnetic sensor information from a second electronic device equipped with the geomagnetic sensor, and process the received output of the geomagnetic sensor of the second electronic device based on a heading direction of the first electronic device and generate azimuth angle information dependent on the heading direction of the first electronic device.

The first electronic device may be a wearable device, and the second electronic device may be a mobile phone. The heading directions of the first electronic device and the second electronic device may be the same direction. In this case, there may be an advantage that, because the wearable device does not need to mount the geomagnetic sensor, it may save the cost, and the wearable device does not need to consider items (e.g., a magnetic field generated within an electronic device) to consider when mounting the geomagnetic sensor.

While the disclosure has been shown and described with reference to certain embodiments thereof, it will be understood by those skilled in the art that various changes in form and details may be made therein without departing from the spirit and scope of the disclosure. Therefore, the scope of the preset disclosure is defined, not by the detailed description but, by the appended claims and there equivalents.

What is claimed is:

1. A method for operating a first electronic device, the method comprising:
detecting a movement of the first electronic device;
receiving direction information of a second electronic device; and
determining an azimuth angle of a heading direction of the first electronic device based on the received direction information of the second electronic device.

2. The method of claim 1, wherein the direction information of the second electronic device comprises an azimuth angle of a heading direction of the second electronic device, which is obtained based on the heading direction of the second electronic device and a magnetic north direction.

3. The method of claim 1, wherein detecting the movement of the first electronic device comprises acquiring movement information of the first electronic device through at least one sensor of the first electronic device.

4. The method of claim 3, wherein the movement information comprises at least one of heading direction information of the first electronic device, posture information of the first electronic device, and rotation information of the first electronic device.

5. The method of claim 4, wherein determining the azimuth angle of the heading direction of the first electronic device comprises determining the azimuth angle of the heading direction of the first electronic device based on the heading direction information of the first electronic device and the received direction information of the second electronic device.

6. The method of claim 5, further comprising determining the azimuth angle of the heading direction of the first electronic device in consideration of at least one of the posture information of the first electronic device, and the rotation information of the first electronic device.

7. The method of claim 6, further comprising, when the movement of the first electronic device is detected while determining the azimuth angle of the heading direction of the first electronic device, correcting the azimuth angle of the heading direction of the first electronic device based on the detected movement of the first electronic device.

8. The method of claim 1, further comprising displaying information corresponding to the determined azimuth angle of the heading direction of the first electronic device.

9. The method of claim 1, further comprising the operation of, before detecting the movement of the first electronic device, determining whether the first electronic device is worn, using a wearing detection sensor of the first electronic device
wherein the first electronic device is a wearable device.

10. The method of claim 9, wherein the wearing detection sensor comprises at least one of a proximity sensor, a heart-beat sensor, a touch sensor, and a medical sensor.

11. The method of claim 1, further, before detecting the movement of the first electronic device, forming a short-range communication link with the second electronic device.

12. The method of claim 11, wherein the short-range wireless communication link uses at least one of WiFi, Bluetooth (BT), Near Field Communication (NFC), and ZigBee communication schemes.

13. The method of claim 11, further comprising, forming the short-range communication link when a specific application is executed.

14. The method of claim 13, wherein the specific application comprises an application displaying a map.

15. A first electronic device comprising:
a sensor for detecting a movement of the first electronic device;
a communication unit for receiving direction information of a second electronic device; and
a processor for determining an azimuth angle of a heading direction of the first electronic device based on the received direction information of the second electronic device.

16. The device of claim 15, wherein the direction information of the second electronic device comprises an azimuth angle of a heading direction of the second electronic device, which is obtained based on the heading direction of the second electronic device and a magnetic north direction.

17. The device of claim 15, wherein the sensor acquires movement information of the first electronic device.

18. The device of claim 17, wherein the movement information comprises at least one of heading direction information of the first electronic device, posture information of the first electronic device, rotation information of the first electronic device.

19. The device of claim 15, further comprising a display for displaying information corresponding to the determined azimuth angle of the heading direction of the first electronic device.

20. An electronic device comprising:
at least one sensor for detecting a movement of the electronic device;
a display; and
at least one processor,
wherein the at least one processor controls to receive direction information of another electronic device, and determine an azimuth angle of a heading direction of the electronic device based on the received direction information of the other electronic device, and display information corresponding to the determined azimuth angle of the heading direction the electronic device through the display.
